(19) United States
(12) Patent Application Publication
(10) Pub. No.: US 2025/0066180 A1
(43) Pub. Date: Feb. 27, 2025

(54) PRESSURE ACTIVATED DISPENSE SYSTEM AND COMPONENTS

(71) Applicant: Starbucks Corporation, Seattle, WA (US)

(72) Inventors: Joseph E. Gormley, Mercer Island, WA (US); Nathan C. Oren, Edgewood, WA (US)

(21) Appl. No.: 18/809,875

(22) Filed: Aug. 20, 2024

Related U.S. Application Data
(60) Provisional application No. 63/578,095, filed on Aug. 22, 2023.

(51) Int. Cl. B67D 1/08

(52) U.S. Cl. CPC B67D 1/0801; B67D 1/0808; B67D 2001/0825

(57) ABSTRACT

A beverage dispenser is provided herein. The beverage dispenser may include a housing and a recess that holds a beverage. The recess may be pressurized to dispense the beverage through a dispensing tube that extends into the housing. The recess may include a base positioned at a bottom of the recess. The base may include a reservoir and the base may draw the beverage towards the reservoir. The dispensing tube may be laterally bisected or longitudinally bisected into a first portion and a second portion that may be removably coupled together.

### INCORPORATION BY REFERENCE TO ANY PRIORITY APPLICATIONS

This application claims priority to U.S. Provisional Patent Application No. 63/578,095, filed Aug. 22, 2023, the entirety of which is incorporated herein by reference.

### FIELD

The present disclosure relates to a pressure activated dispensing system and components, such as, in certain embodiments, a pressure activated dispensing system with a central dispense head and beverage dispensers that may be used without a container for a beverage.

### SUMMARY

For purposes of this summary, certain aspects, advantages, and novel features are described herein. It is to be understood that not necessarily all such advantages may be achieved in accordance with any particular embodiment. Thus, for example, those skilled in the art will recognize the disclosures herein may be embodied or carried out in a manner that achieves one or more advantages taught herein without necessarily achieving other advantages as may be taught or suggested herein.

In some embodiments, a beverage dispenser may include a housing, a recess in the housing configured to hold a beverage, an inlet, and a dispensing tube. The dispensing tube may include a first end and a second end. The recess may be pressurized via the inlet. The second end of the dispensing tube may be positioned outside of the recess, and the first end of the dispensing tube may extend into the recess so the beverage in the recess is dispensed through the second end of the dispensing tube when the recess is pressurized.

In some embodiments, the beverage dispenser may include a base positioned at a bottom of the recess, wherein the base is configured to draw the beverage towards a center of the base.

In some embodiments, the base may be integrated into the recess.

In some embodiments, the base may include a reservoir at the center of the base, wherein the reservoir extends into the base towards a bottom of the recess.

In some embodiments, the first end of the dispensing tube may extend into the reservoir.

In some embodiments, the beverage dispenser, may include a plug removably inserted into the reservoir.

In some embodiments, the beverage dispenser may include an agitator extending from the reservoir.

In some embodiments, the dispensing tube may be longitudinally bisected.

In some embodiments, the dispensing tube may be laterally bisected.

In some embodiments, a beverage dispensing system may include a plurality of beverage dispensers, and each of the beverage dispensers may include a housing, a recess in the housing configured to hold a beverage, an inlet, and a dispensing tube. The dispensing tube may include a first end and a second end. The recess may be pressurized via the inlet. The second end of the dispensing tube may be positioned outside of the recess, and the first end of the dispensing tube may extend into the recess so the beverage in the recess is dispensed through the second end of the dispensing tube when the recess is pressurized. The beverage dispensing system may include a dispensing head including a plurality of openings, and the second end of the dispensing tube of each of the plurality of beverage dispensers may be inserted into one of the plurality of openings.

In some embodiments, the beverage in the recess of each of the plurality of beverage dispensers may dispensed into a beverage container positioned under the dispensing head.

In some embodiments, the beverage dispensing system may include a communication module configured to receive a beverage order from a point of sale system.

In some embodiments, the beverage dispensing system may be configured to dispense the beverage in the recess of at least one of the plurality of beverage dispensers based on the beverage order.

In some embodiments, the beverage dispensing system may include a user interface configured to receive a user input indicative of a particular beverage to dispense. The particular beverage may be the beverage in the recess of at least one of the plurality of beverage dispensers, and the beverage dispensing system may dispense the particular beverage based on the user input.

In some embodiments, the dispensing tube of one or more of the plurality of beverage dispensers may be bisected from the first end of the dispensing tube to the second end of the dispensing tube.

In some embodiments, a dispensing tube for a beverage dispenser may include a first end, a second end opposite the first end, a first portion extending from the first end to the second end, and a second portion extending from the first end to the second end. The first portion may include a first body and a first recess in the first body. The second portion may include a second body and a second recess in the second body. The first portion and the second portion may be configured to removably couple together so the first recess and the second recess form an opening in the dispensing tube extending from the first end to the second end.

In some embodiments, the dispensing tube may be longitudinally bisected so the first portion forms a right half of the dispensing tube and the second portion forms a left half of the dispensing tube.

In some embodiments, the dispensing tube may be laterally bisected so the first portion forms a top half of the dispensing tube and the second portion forms a bottom half of the dispensing tube.

In some embodiments, the first portion may include seals, and the second portion may include seal channels, the seals may extend into the seal channels to form a watertight seal when the first portion and the second portion are coupled together.

In some embodiments, the dispensing tube may include clamps configured to couple the first portion to the second portion.

### BRIEF DESCRIPTION OF THE DRAWINGS

Various embodiments are depicted in the accompanying drawings for illustrative purposes and should in no way be interpreted as limiting the scope of the embodiments. Furthermore, various features of different disclosed embodiments can be combined to form additional embodiments, which are part of this disclosure.

FIG. 1A illustrates an embodiment of a beverage dispenser.

FIG. 1B illustrates a section view of the beverage dispenser of FIG. 1A

FIG. 2A illustrates another embodiment of a beverage dispenser.

FIG. 2B illustrates a section view of the beverage dispenser of FIG. 2A

FIG. 2C illustrates another section view of the beverage dispenser of FIG. 2A with a secondary container in the beverage dispenser.

FIG. 3 illustrates a section view of the beverage dispenser of FIG. 2A with a plug.

FIG. 4 illustrates a section view of the beverage dispenser of FIG. 2A with an agitator.

FIG. 5A illustrates a top view of an embodiment of a beverage dispensing system.

FIG. 5B illustrates a dispensing head of the beverage dispensing system of FIG. 5A

FIG. 5C illustrates a schematic of an embodiment of the beverage dispensing system of FIG. 5A.

FIG. 5D illustrates another schematic of an embodiment of the beverage dispensing system of FIG. 5A.

FIG. 6A illustrates a section view of an embodiment of a first portion of a dispensing tube.

FIG. 6B illustrates a section view of an embodiment of a second portion of a dispensing tube.

FIG. 6C illustrates a partial top view of the dispensing tube of FIGS. 6A and 6B.

FIG. 6D illustrates an embodiment of a clamp for the dispensing tube of FIGS. 6A and 6B

FIG. 7A illustrates a section view of another embodiment of a dispensing tube.

FIG. 7B illustrates another section view of the dispensing tube of FIG. 7A.

FIG. 7C illustrates another section view of the dispensing tube of FIG. 7A.

FIG. 7D illustrates another view of the dispensing tube of FIG. 7A.

### DETAILED DESCRIPTION

Although several embodiments, examples, and illustrations are disclosed below, it will be understood by those of ordinary skill in the art that the system, methods, and devices described herein extend beyond the specifically disclosed embodiments, examples, and illustrations and includes other uses of the system, methods, and devices and obvious modifications and equivalents thereof. Embodiments of the disclosure are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the disclosure. In addition, embodiments of the disclosure may comprise several novel features and no single feature is solely responsible for its desirable attributes or is essential to practicing the system, methods, and devices herein described.

Certain beverage and/or beverage components can be distributed for drink preparation using pressure driven beverage dispensers. In such systems, beverage dispensers may be pressurized such that a beverage and/or beverage component (e.g., milks, creams, juices, sauces, syrups, flavorings, etc.) may be disbursed or dispensed from the beverage dispenser into a beverage container (e.g., a cup, glass, etc.). The beverage and/or beverage component may be inserted into a secondary container (e.g., a bag) and the secondary container may be inserted into a housing of the beverage dispenser. The beverage dispenser may pressurize the housing of the fluid dispenser and/or the secondary container to disburse or dispense the beverage and/or beverage component from the secondary container into the beverage container.

However, inserting the beverage and/or beverage component into a secondary container before inserting the beverage and/or beverage component into the beverage dispenser may require additional labor, particularly at high volume beverage producers (e.g., coffee stores, cafes, restaurants, etc.) that may empty beverage dispensers multiple times throughout a day. If the secondary container is not reusable, the secondary container must be thrown away once the secondary container is emptied, which may lead to large amounts of waste.

Additionally, pressure driven beverage dispensers may disburse or dispense beverages and/or beverage components via a dispensing tube. If the beverage dispenser is used in a coffee store or other food service establishment, the dispensing tube and other components of the beverage dispenser that contact the fluid must be cleaned according to local code or regulations. The dispensing tube is typically u-shaped and includes multiple bends or bent portions. Accordingly, solids (e.g., pulp, etc.) in the beverages and/or beverage components may build up at the bends or bent portions of the dispensing tube. Due to the shape of the dispensing tube, cleaning the dispensing tube maybe difficult, and it may be difficult to determine if the dispensing tube is fully cleaned before use.

In accordance with several embodiments, the systems, methods, and devices described herein advantageously may dispense beverages and/or beverage components without the use of a secondary container. Therefore, the labor required to refill the beverage dispenser a beverage and/or beverage component may be reduced when compared to beverage dispensers that require a secondary container, since an empty secondary container does not need to be removed from the beverage dispenser each time the beverage dispenser needs to be refilled. If a high volume beverage producer (e.g., coffee stores, cafes, restaurants, etc.) receives the beverage and/or beverage component in a container that is not compatible with the beverage dispenser, the beverage and/or beverage component does not need to be inserted into a secondary container before it is inserted. Additionally, the beverage dispenser eliminates the large amount of waste associated with using secondary containers and the labor required to clean reusable secondary containers.

The beverage dispenser may include a base with a reservoir. The base may be shaped to draw or force a beverage and/or beverage component in the beverage dispenser toward the reservoir. The reservoir may reduce a volume of beverage and/or beverage component that is left in the beverage dispenser when the beverage dispenser is unable to dispense more beverage and/or beverage component. Beverages and/or beverage components may be inserted directly into the beverage dispensers. The beverage dispensers may include a dispensing tube that may be bisected along a length of the dispensing tube to simplify cleaning of the dispensing tube in order to reduce the labor needed to clean the dispensing tube.

Furthermore, the beverage dispenser may dispense the beverage and/or beverage component by pressurizing a recess (e.g., inner volume) of the beverage dispenser. Therefore, a user must only push a user input to dispense the beverage and/or beverage component, instead of manually pumping a beverage dispenser to dispense the beverage and/or beverage component. At high volume beverage producers, staff (e.g., a barista) may dispense hundreds of beverages or beverage components during a shift. Manually pumping a beverage dispenser can lead to arm fatigue and potential injuries. By dispensing the beverage and/or beverage component with only a push of a user input, the beverage dispenser may reduce arm fatigue experienced by staff and the potential of injuries.

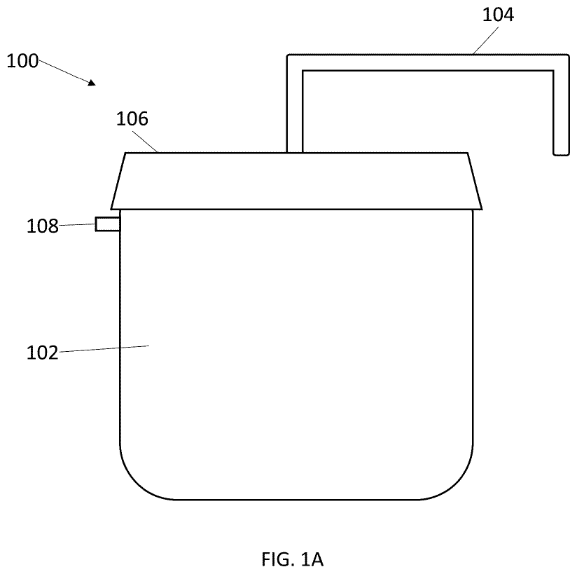

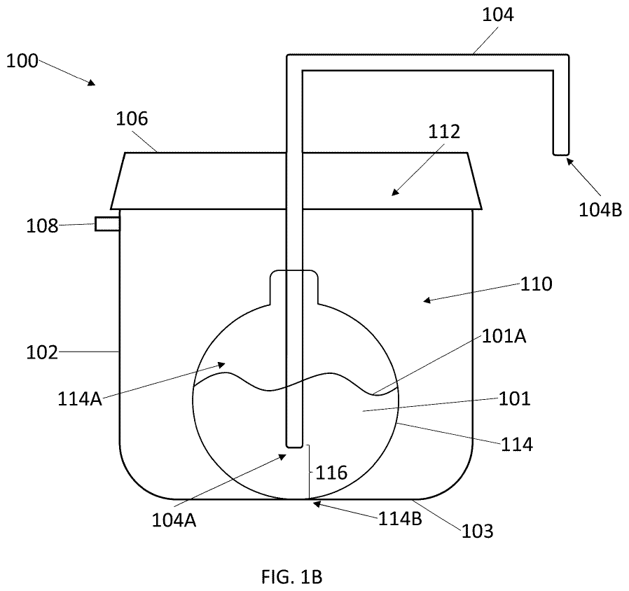

FIGS. 1A and 1B show a beverage dispenser 100. The beverage dispenser 100 may include a housing 102, a dispensing tube 104, a cover 106, and/or an inlet 108. The housing 102 may form a recess 110. The housing 102 may include an opening 112 to the recess 110. The cover 106 may be coupled to the housing 102 so the cover 106 may be positioned over the opening 112. The cover 106 may form an air-tight or substantially airtight seal with the housing 102. The recess 110 may be pressurized when the cover 106 is positioned over the opening 112, as described further below. The cover 106 may be removably coupled to the housing 102. In some embodiments, the cover 106 may be rotatably coupled to the housing 102.

As shown in FIG. 1B, a secondary container 114 may be inserted into the recess 110 via the opening 112. The secondary container 114 may be positioned so a bottom 114B of the secondary container 114 is supported by a bottom 103 of the housing 102. The secondary container 114 may hold a beverage 101 in an interior volume 114A of the secondary container 114. The beverage 101 may include a beverage base (e.g., milks, creams, juices, beverage bases, etc.) and/or a beverage component (e.g., sauces, syrups, flavorings, etc.). The secondary container 114 may include plastic, paper, paperboard, cardboard, polyethylene (PE), high-density polyethylene (HDPE), low-density polyethylene (LDPE), polyethylene terephthalate (PET), and/or any other material.

The dispensing tube 104 may be inserted into the recess 110 of the housing 102 through the cover 106. The cover 106 may form an air-tight or substantially air-tight seal with the dispensing tube 104. The dispensing tube 104 may extend from a first end 104A to a second end 104B opposite the first end 104A. The dispensing tube 104 may be inserted into the recess 110 so the first end 104A dispensing tube 104 extends into the interior volume 114A of the secondary container 114 and the second end 104B of the dispensing tube 104 is positioned outside of the housing 102. The dispensing tube 104 may fluidly connect the interior volume 114A of the secondary container 114 to a volume outside of the housing 102. A pressure in the interior volume 114A of the secondary container 114 may be a same pressure as a pressure outside of the housing 102. The secondary container 114 may form an air-tight and/or liquid-tight seal with the dispensing tube 104. The dispensing tube 104 may be shaped so the first end 104A and the second end 104B face a same direction. In some embodiments, the dispensing tube 104 may be u-shaped.

The beverage 101 in the interior volume 114A of the secondary container 114 may be dispensed from the beverage dispenser 100 at the second end 104B of the dispensing tube 104. The recess 110 may be pressurized in order to dispense the beverage 101. Pressurized air and/or any other gas may be inserted or forced into the recess 110 via the inlet 108. The pressurized air and/or other gas may be pressurized at a pressure higher than a pressure in the recess 110 so the pressure in the recess 110 increases when the pressurized air and/or other gas is inserted or force into the recess 110. The pressure of the pressurized air and/or other gas may be higher than the pressure outside the housing 102 so the pressure in the recess 110 is higher than a pressure in the secondary container 114 and/or outside the housing 102. Accordingly, the pressure in the recess 110 may force or dispense the beverage 101 through the dispensing tube 104.

The inlet 108 may be coupled or connected to the interior volume 114A of the secondary container 114 so pressurized air and/or other gas may be inserted or forced into the interior volume 114A of the secondary container 114. The pressurized air and/or other gas may be pressurized at a pressure higher than the pressure in the interior volume 114A of the secondary container 114 and/or outside of the housing 102. When the pressurized air and/or other gas is inserted or forced into the interior volume 114A of the secondary container 114, the pressure in the interior volume 114A may increase so the pressure in the interior volume 114A is higher than the pressure outside the housing 102. Accordingly, the pressure in the interior volume 114A of the secondary container 114 may force or dispense the beverage 101 through the dispensing tube 104.

When the dispensing tube 104 is inserted into the secondary container 114, the first end 104A of the dispensing tube 104 may be positioned a distance 116 from the bottom 103 of the housing 102 and/or the bottom 114B of the secondary container 114 to allow the beverage 101 in the interior volume 114A to enter the dispensing tube 104 at the first end 104A. Therefore, when a top surface 101A of the beverage 101 in the interior volume 114A is at or below the first end 104A of the dispensing tube 104, the beverage 101 may not enter the dispensing tube 104 via the first end 104A. Accordingly, at least a portion of the beverage 101 in the interior volume 114A may not be dispensed through the dispensing tube 104.

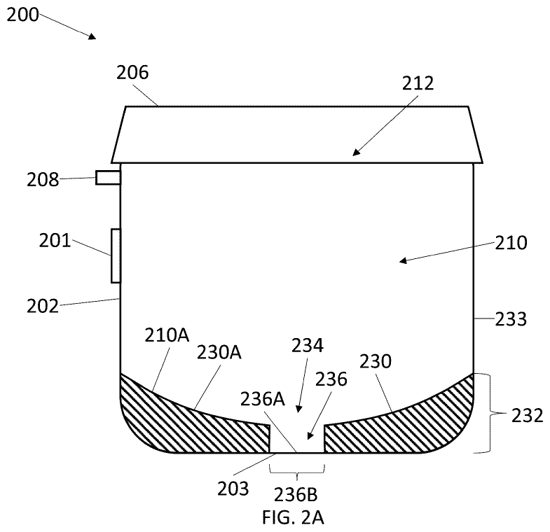

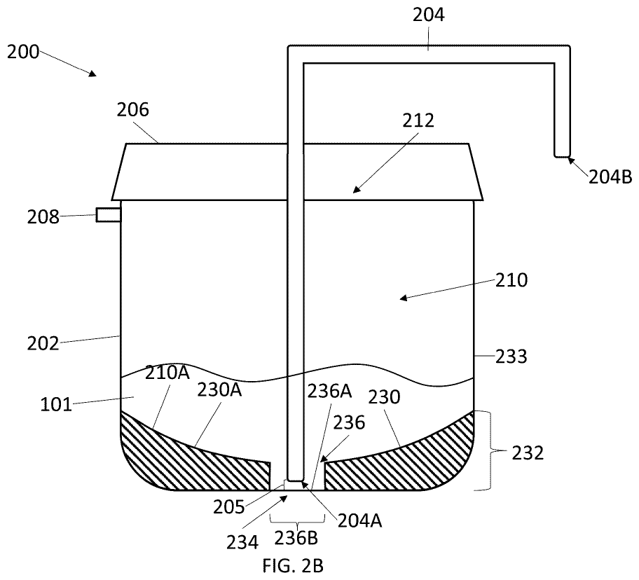

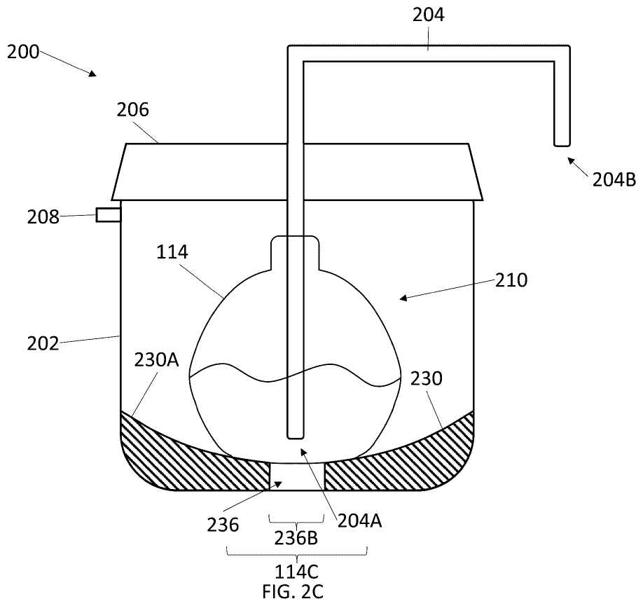

FIGS. 2A-4 illustrate another beverage dispenser 200 for dispensing beverages. Common features between the beverage dispenser 200 and the beverage dispenser 100 will not be described again but are incorporated here in their entirety. The beverage dispenser 200 may include a housing 202 that forms a recess 210. In some embodiments, the housing 202 and/or the recess 210 may be cooled via a cooling system 201, as shown in FIG. 2A. The cooling system 201 may include a thermoelectric cooling system, a Peltier cooler, and/or any other cooling system. The cooling system 201 may be positioned in the housing 202.

The recess 210 of the housing 202 may include a base 230. In some embodiments, the base 230 may be integrated into the recess. In some embodiments, the base 230 may be removable. A top surface 230A of the base 230 may form at least a portion of a bottom surface 210A of the recess 210. The base 230 may include a thickness 232. The thickness 232 of the base 230 may be larger (e.g., thicker) at a sidewall 233 of the housing 202 than at or near a center 234 of the base 230. The thickness 232 of the base 230 may decrease from the sidewall 233 to the center 234 of the base 230. The thickness 232 of the base 230 may increase from the center 234 of the base 230 to the sidewall 233. Accordingly, at least a portion of the base 230 may draw or force a fluid in the recess 210 towards the center 234 of the base 230.

The base 230 may include a reservoir 236. The reservoir 236 may be a cutout or recess in the base 230. The reservoir 236 may extend into the base 230 so a bottom surface 236A of the reservoir 236 is positioned between the top surface 230A of the base 230 and a bottom 203 of the housing 202. The reservoir 236 may be positioned at the center 234 of the recess 210 so the base 230 may draw or force fluid in the recess 210 towards and/or into the reservoir 236.

As shown in FIG. 2B, the beverage dispenser 200 may be used without a secondary container 114. The beverage 101 may be inserted (e.g., poured) directly into the recess 210. The beverage 101 may inserted into the recess 210 through an opening 212 to the recess 210. Therefore, the beverage 101 does not need to be inserted into a secondary container 114 in order to dispense the beverage with the beverage dispenser 200. A dispensing tube 204 may be inserted into the recess 210 through a cover 206. Pressurized air and/or any other gas may be inserted or forced into the recess 210 via an inlet 208 to dispense the beverage 101 in the recess 210 via the dispensing tube 204. The beverage 101 may be dispensed only when the recess 210 is pressurized. The beverage 101 may be dispensed until the recess 210 is depressurized. The recess 210 may be depressurized to stop dispensing the beverage 101. The beverage dispenser 200 is not designed to hold pressure when not in use. The pressurized gas may apply pressure directly to the beverage 101 in the recess 210. The pressure of the pressurized gas may be selected so the pressurized gas does not alter properties of the beverage 101 in the recess 210. For example, the pressure may be selected so the pressurized gas does not carbonate the beverage 101 in the recess 210. In some embodiments, the pressure of the gas may include a pressure of 0.5 psi, 0.6 psi, 0.7 psi, 0.8 psi, 0.9 psi, 1.0 psi, 1.1 psi, 1.2 psi, 1.3 psi, 1.4 psi, 1.5 psi, 2.0 psi, 2.5 psi, 3.0 psi, 3.5 psi, 4.0 psi, 4.5 psi, 5 psi, 10 psi, 15 psi, 20 psi, and/or any value between the aforementioned valued. In some embodiments, the pressure of the gas may include a pressure between 0.5 psi and 2.0 psi. In some embodiments, the pressure of the gas may include a pressure between 0.8 psi and 1.2 psi.

The beverage dispenser 200 may be configured to dispense an individual serving of the beverage 101. The beverage dispenser 200 may be configured to dispense an individual serving of the beverage 101 each time a user interface is actuated (e.g., user interface 506). The individual serving of the beverage 101 may include 3 fluid ounces to 96 fluid ounces (e.g., from 3 fluid ounces to 20 fluid ounces, from 3 fluid ounces to 30 fluid ounces, from 8 fluid ounces to 30 fluid ounces, from 8 fluid ounces to 64 fluid ounces, overlapping ranges thereof, or any value within the recited ranges such as 3 fluid ounces, 4 fluid ounces, 8 fluid ounces, 12 fluid ounces, 16 fluid ounces, 20 fluid ounces, 30 fluid ounces, 31 fluid ounces, 48 fluid ounces, 96 fluid ounces).

The dispensing tube 204 may be inserted into the recess 210 so a first end 204A of the dispensing tube 204 extends into the reservoir 236. The first end 204A of the dispensing tube 204 may be positioned a distance 205 from the bottom surface 236A of the reservoir 236. The distance 205 may include a minimum distance the first end 204A may be positioned from the bottom surface 236A without preventing or inhibiting the beverage 101 from entering the first end 204A of the dispensing tube 204. The distance 205 may be selected based on a viscosity of the beverage 101. In some embodiments, the distance 205 may include a distance of 0.5 mm, 0.75 mm, 1.0 mm, 1.25 mm, 1.5 mm, 1.75 mm, 2.0 mm, 2.25 mm, 2.5 mm, 2.75 mm, 3.0 mm, 3.5 mm, 4.0 mm, 4.5 mm, 5.0 mm, and/or any value between the aforementioned values. In some embodiments, the distance 205 may include a distance between 0.5 mm and 3.0 mm. In some embodiments, the distance 205 may include a distance between 0.75 mm and 2.25 mm. Since the reservoir 236 is a portion of the bottom surface 210A of the recess 210, the portion of the beverage 101 that may not be dispensed through the dispensing tube 104 may be a smaller volume of the beverage 101 than the portion of the beverage 101 that may not be dispensed when the beverage dispenser 100 is used with a secondary container 114. Accordingly, the reservoir 236 may reduce or minimize a volume of the portion of the beverage 101 that may not be dispensed through the dispensing tube 104.

As shown in FIG. 2C, the beverage dispenser 200 may be used with a secondary container 114. A width 236B of the reservoir 236 may be smaller than a width 114C of the bottom 114B of the secondary container 114. When the secondary container 114 is inserted into the recess 110 at least a portion of the bottom 114B of the secondary container 114 may contact the top surface 230A of the base 230 and the top surface 230A may support the secondary container 114.

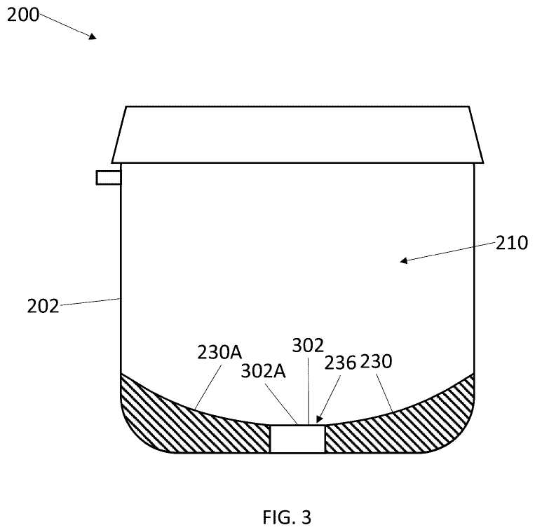

As shown in FIG. 3, the beverage dispenser 200 may include a plug 302. The plug 302 may be removably inserted into the reservoir 236. The plug 302 may be substantially the same size and/or shape as the reservoir 236. In some embodiments, when the plug 302 is inserted into the reservoir 236 a top surface 302A of the plug 302 may be aligned or substantially aligned with the top surface 230A of the base 230 so the top surface 302A of the plug 302 and the top surface 230A of the base 230 form a continuous surface. Therefore, when a secondary container 114 is inserted into the recess 210, the top surface 302A of the plug 302 and the top surface 230A of the base 230 may contact the bottom 114B of the secondary container 114 to support the secondary container 114.

The plug 302 may be inserted into the reservoir 236 in order to reduce the size of the reservoir 236. When the plug 302 is inserted into the reservoir 236 a top surface 302A of the plug 302 may be positioned between the top surface 230A of the base 230 and the bottom surface 236A of the reservoir 236.

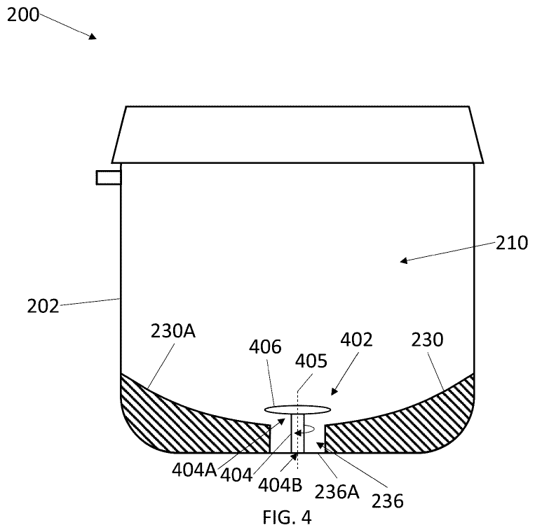

As shown in FIG. 4, the beverage dispenser 200 may include an agitator 402. The agitator 402 may include an arm 404 and an agitation portion 406. The arm 404 may be configured to rotate around an axis 405 that extends from a first end 40A of the arm 404 to a second end 404B of the arm 404. The agitation portion 406 may be coupled to the first end 404A of the arm 404. When the arm 404 rotates around the axis 405, the agitation portion 406 may rotate around the axis 405 to agitate and/or mix a beverage in the recess 210. A motor (not shown) may rotate the arm 404 around the axis 405. The motor may be positioned in the arm 404 or the motor may be positioned in the housing 202.

The agitator 402 may be removably inserted into the recess 210. The agitator 402 may be inserted into the recess 210 so a second end 404B of the arm 404 opposite the first end 404A is removably coupled to the bottom surface 236A of the reservoir 236. The agitation portion 406 may be positioned in the reservoir 236 or in a portion of the recess 210 between the top surface 230A of the base 230 and the opening 212.

The agitator 402 may be configured to extend from and/or retract into the reservoir 236 and/or the bottom surface 236A of the reservoir 236. Accordingly, when the dispensing tube 204 is inserted into the recess 210 and/or the reservoir 236, the agitator 402 may retract into the reservoir 236 and/or the bottom surface 236A of the reservoir 236 so the agitation portion 406 of the agitator 402 does not contact the dispensing tube 204. When the dispensing tube 204 is removed from the recess 210 and/or the reservoir 236, the agitator 402 may extend from the reservoir 236 and/or the bottom surface 236A so the agitation portion 406 of the agitator 402 is positioned between the top surface 230A of the base 230 and the opening 212.

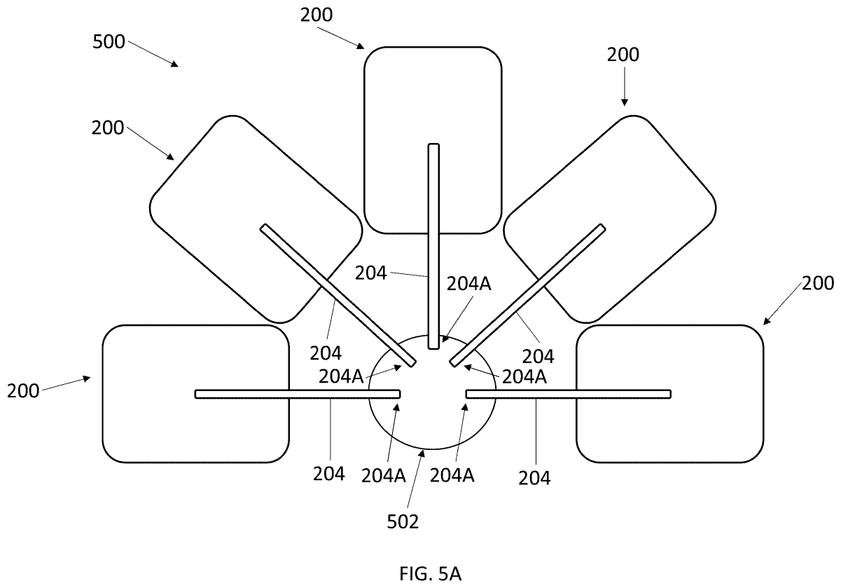

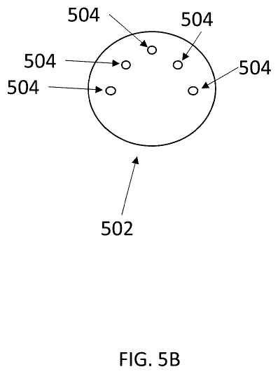

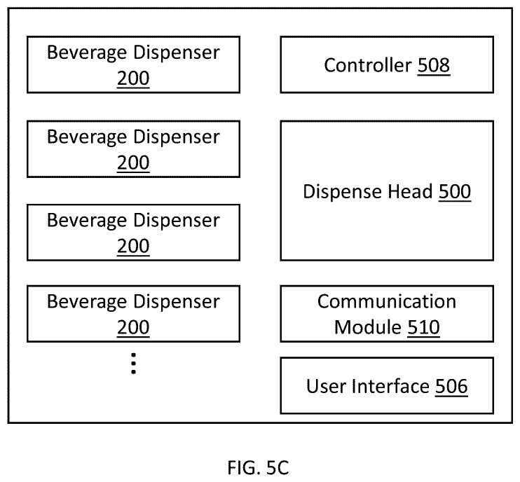

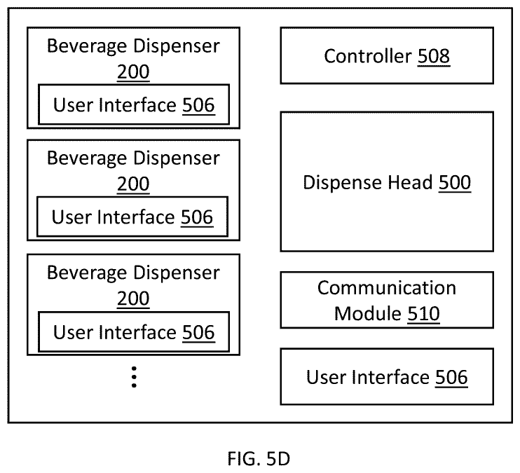

FIGS. 5A and 5B illustrate a dispensing system 500. The dispensing system 500 may include beverage dispensers 200 and a dispense head 502. In some embodiments, the dispensing system 500 may include one (1) beverage dispenser 200, two (2) beverage dispensers 200, three (3) beverage dispensers 200, four (4) beverage dispensers 200, five (5) beverage dispensers 200, six (6) beverage dispensers 200, seven (7) beverage dispensers 200, eight (8) beverage dispensers 200, nine (9) beverage dispensers, and/or ten (10) beverage dispensers. In some embodiments, the dispensing system 500 may include between two (2) beverage dispensers 200 and ten (10) beverage dispensers 200. In some embodiments, the dispensing system 500 may include between two (2) beverage dispensers 200 and six (6) beverage dispensers 200.

The dispensers 200 may be positioned so a second end 204B of the dispensing tube 204 of each beverage dispenser 200 may be coupled to and/or in fluid connection with the dispense head 502. As shown in FIG. 5B, the dispense head 502 may include openings 504. The openings 504 may be positioned so a dispensing tube 204 of each beverage dispenser 200 may be coupled to, inserted into, and/or in fluid connection with an opening 504.

A beverage container may be positioned under the dispense head 502 and a beverage or beverage component may be dispensed into the beverage container via the dispense head 502 and/or the openings 504. The openings 504 may be positioned so the beverage container may be positioned under every opening 504 simultaneously (e.g., at the same time). Accordingly, a beverage or beverage component may be dispensed into the beverage container via any of the openings 504 without moving the beverage container. A plurality of beverages or beverage components may be dispensed into the beverage container simultaneously (e.g., at the same time) or substantially simultaneously.

A plurality of beverage containers may be positioned under the dispense head 502 and a beverage or beverage components may be dispensed into each of the plurality of beverage containers. The openings 504 may be positioned so a different beverage container may be positioned under each opening 504. Accordingly, a beverage or beverage component may be dispensed into each beverage container via a different opening 504 simultaneously (e.g., at the same time) or substantially simultaneously.

Each beverage dispenser 200 may include a beverage or a beverage component. In some embodiments, each beverage dispenser 200 may include a different beverage or beverage component. In some embodiments, at least two beverage dispensers 200 may include a same beverage or beverage component. In some embodiments, each beverage dispenser 200 may include the same beverage or beverage component.

FIGS. 5C-5D show schematic illustrations of the dispensing system 500. The dispensing system 500 may include beverage dispensers 200 and the dispense head 502. The dispensing system 500 may include a user interface 506, a controller 508, and/or a communication module 510. The communication module 510 may communicate with a point of sale system and/or any other computer system. The communication module 510 may receive one or more beverages or beverage orders. The controller 508 may receive the one or more beverages or beverage orders from the communication module 510. The controller 508 may transmit instructions to the beverage dispensers 200 and/or the dispense head 502. The instructions may communicate to one or more beverage dispensers 200 to dispense a beverage or beverage component. The instructions may communicate to the one or more beverage dispensers 200 to pressurize the recess 210 of the one or more beverage dispensers 200 in order to dispense the beverage or beverage component.

The user interface 506 may be configured to receive one or more inputs from a user. As shown in FIG. 5D, in some embodiments, each of the beverage dispensers 200 may include a user interface 506. The user interface 506 may include a scanner configured to scan a beverage order. The user interface 506 may scan a barcode, a QR code, and/or any other computer readable code on the beverage order. The user interface 506 may be configured to scan or read an RFID tag of the beverage order. When the user interface 506 scans the beverage order, the user interface 506 may transmit the beverage order to the controller 508. The user interface 506 may include one or more buttons, inputs, and/or a touchscreen. The user interface 506 may be configured to receive a user input or selection that may indicate which beverage dispenser 200 to dispense a beverage or beverage component from. When the user interface 506 receives the user input or selection, the user interface 506 may transmit the user input or selection to the controller 508.

The user interface 506 may include a display configured to display information to the user. The user interface 506 may be configured to display a beverage or beverage component stored in each of the beverage dispensers 200, an amount or volume of a beverage or beverage component in each of the beverage dispensers 200, a dispensing queue, a temperature in the recess 210 of each beverage dispenser 200, an indication to clean the beverage dispenser 200 or one or more components of the beverage dispenser 200 and/or any other information.

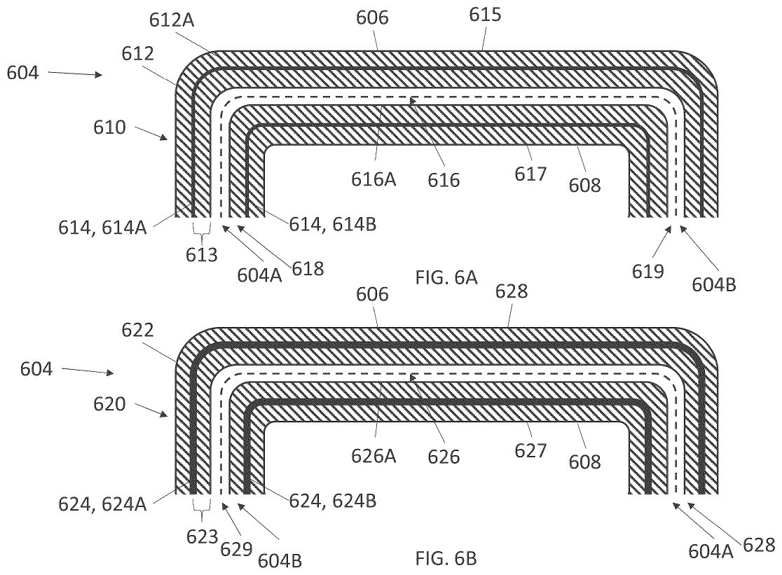

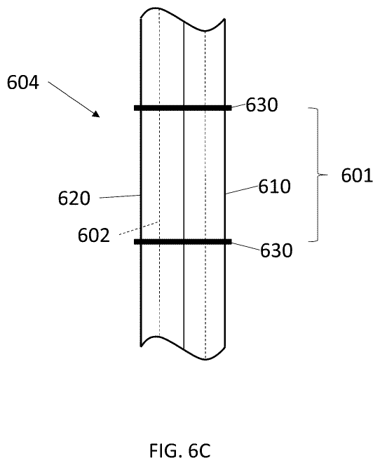

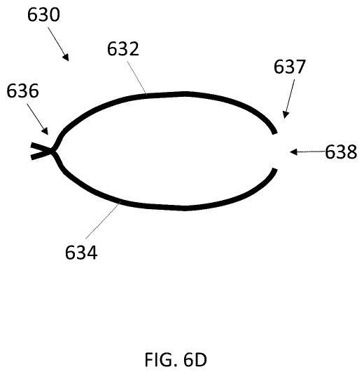

FIGS. 6A-6D illustrate a dispensing tube 604. The dispensing tube 604 may be bisected from the first end 604A of the dispensing tube 604 to the second end 604B of the dispensing tube 604 opposite the first end 604A. The dispensing tube 604 may be longitudinally bisected (e.g., from a top 606 of the dispensing tube 604 to a bottom 608 of the dispensing tube 604. Accordingly, the dispensing tube 604 may include a first portion 610, as shown in FIG. 6A, and a second portion 620, as shown in FIG. 6B. The first portion 610 may form a first side (e.g., right half) of the dispensing tube 604 and the second portion 620 may form a second side (e.g., left half) of the dispensing tube 604. The first portion 610 and the second portion 620 may extend from the first end 604A of the dispensing tube 604 to the second end 604B of the dispensing tube. The first portion 610 and the second portion 620 may be coupled together to form the dispensing tube 604.

As shown in FIG. 6A, the first portion 610 may include a body 612, seals 614, and/or a recess 616. The first portion 610 may include a first end 618 and a second end 619. The first end 618 of the first portion 610 may be the first end 604A of the dispensing tube 604, and the second end 619 of the first portion 610 may be the second end 604B of the dispensing tube 604. The body 612 may extend from the first end 618 of the first portion 610 to the second end 619 of the first portion 610. The body 612 may be shaped so the first end 618 of the first portion 610 and the second end 619 of the first portion 610 face a same direction. In some embodiments, the body 612 may be u-shaped.

The recess 616 may extend into the body 612 from a bisection surface 612A of the body 612. The recess 616 may extend from the first end 618 of the first portion 610 to the second end 619 of the first portion 610 along a centerline 611 of the first portion 610. The recess 616 may be shaped so a cross-section of the recess 616 includes a same shape as a cross-section of the body 612. The recess 616 may be shaped so the cross-section of the recess 616 includes a different shape as the cross-section of the body 612. The cross-section of the recess 616 may be shaped as a rectangle, a semi-circle, a square, a triangle, a semi-oval, and/or any other shape.

The seals 614 may be coupled to the body 612 on the bisection surface 612A of the body 612. The seals 614 may extend from the first end 618 of the first portion 610 to the second end 619 of the first portion 610. A first seal 614A may be positioned between the recess 616 and a top 615 of the first portion 610. A second seal 614B may be positioned between the recess 616 and a bottom 617 of the first portion 610. In some embodiments, the seals 614 may be positioned along an edge 616A of the recess 616. In some embodiments, the seals 614 may be positioned a distance 613 from the edge 616A of the recess 616. The seals 614 may be include silicone, platinum cured silicone, neoprene, ethylene propylene diene terpolymer (EPDM), and/or any other material commonly used for watertight scaling.

As shown in FIG. 6B, the second portion 620 may include a body 622, seal channels 624, and/or a recess 626. The second portion 620 may include a first end 628 and a second end 629. The first end 628 of the second portion 620 may be the first end 604A of the dispensing tube 604, and the second end 629 of the second portion 620 may be the second end 604B of the dispensing tube 604. The body 622 may extend from the first end 628 of the second portion 620 to the second end 629 of the second portion 620. The body 622 may be shaped so the first end 628 of the second portion 620 and the second end 629 of the second portion 620 face a same direction. In some embodiments, the body 622 may be u-shaped.

The recess 626 may extend into the body 622 from a bisection surface 622A of the body 622. The recess 626 may extend from the first end 628 of the second portion 620 to the second end 629 of the second portion 620 along a centerline 621 of the second portion 620. In some embodiments, the recess 626 may be shaped so a cross-section of the recess 626 includes a same shape as a cross-section of the body 622. In some embodiments, the recess 626 may be shaped so the cross-section of the recess 626 includes a different shape from the cross-section of the body 622. The cross-section of the recess 626 may be shaped as a rectangle, a semi-circle, a square, a triangle, a semi-oval, and/or any other shape.

The seal channels 624 may be positioned on the body 622 on the bisection surface 622A of the body 622. The seal channels 624 may extend from the first end 628 of the second portion 620 to the second end 629 of the second portion 620. A first seal channel 624A may be positioned between the recess 626 and a top 615 of the second portion 620. A second seal channel 624B may be positioned between the recess 626 and a bottom 627 of the second portion 620. In some embodiments, the seal channels 624 may be positioned along an edge 626A of the recess 626. In some embodiments, the seal channels 624 may be positioned a distance 623 from the edge 626A of the recess 626.

As shown in FIG. 6C, the first portion 610 of the dispensing tube 604 and the second portion 620 of the dispensing tube 604 may be coupled together to form the dispensing tube 604. The first portion 610 and the second portion 620 may be coupled together so the bisection surface 612A of the body 612 of the first portion 610 contacts the bisection surface 622A of the body 622 of the second portion 620. The first portion 610 and the second portion 620 may be coupled together so the first end 618 of the first portion 610 is aligned with the first end 628 of the second portion 620 and/or the second end 619 of the first portion 610 is aligned with the second end 629 of the second portion 620.

When the first portion 610 is coupled to the second portion 620, the recess 616 of the first portion 610 and the recess 626 of the second portion 620 may form an opening 602 through the dispensing tube 604 that extends from the first end 604A of the dispensing tube 604 to the second end 604B of the dispensing tube 604.

When the first portion 610 and the second portion 620 are coupled together, the seals 614 may align with the seal channels 624 so the seals 614 extend into and/or are positioned in the seal channels 624. The first seal 614A may align with the first seal channel 624A so the first seal 614A extends into and/or is positioned in the first seal channel 624A. The second seal 614B may align with the second seal channel 624B so the second seal 614B extends into and/or is positioned in the second seal channel 624B.

The seals 614 and the seal channels 624 may form a watertight seal. The seals 614 and the seal channels 624 may prevent or inhibit a beverage and/or beverage component in the opening 602 of the dispensing tube 604 from leaking or flowing out of the opening 602 towards the top 606 and/or the bottom 608 of the dispensing tube 604. Accordingly, the beverage and/or beverage component may only flow out of the opening 602 at the first end 604A and/or the second end 604B.

The first portion 610 and the second portion 620 may be coupled together via clamps 630. The clamps 630 may be configured to prevent or inhibit the first portion 610 and the second portion 620 from decoupling. The clamps 630 be coupled to the dispensing tube 604 (e.g., the first portion 610 and the second portion 620) so the clamps 630 are separated by a distance 601.

As shown in FIG. 6D, the clamp 630 may include a first arm 632 and a second arm 634. The first arm 632 and the second arm 634 may be rotatably coupled at a first end 636 of the clamp 630. The first arm 632 and the second arm 634 may be configured to rotate between an open position and a closed position. When the first arm 632 and the second arm 634 are in the open position, a gap 638 between (e.g., a distance between) the first arm 632 and the second arm 634 at a second end 637 of the clamp 630 may be larger than a distance between the top 606 of the dispensing tube 604 and the bottom 608 of the dispensing tube 604 so the dispensing tube 604 may be inserted into the clamp 630 (e.g., between the first arm 632 and the second arm 634) via the gap 638. When the first arm 632 and the second arm are in the closed position, the first arm 632 may contact or be coupled to the second arm 634 at the second end 637 of the clamp 630. The first arm 632 and/or the second arm 634 may be biased towards the closed position. Accordingly, the first arm 632 and/or the second arm 634 may resist rotating from the closed position to the open position.

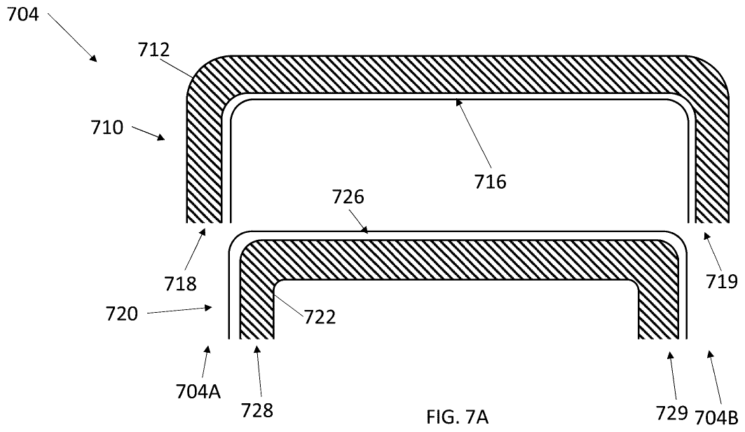

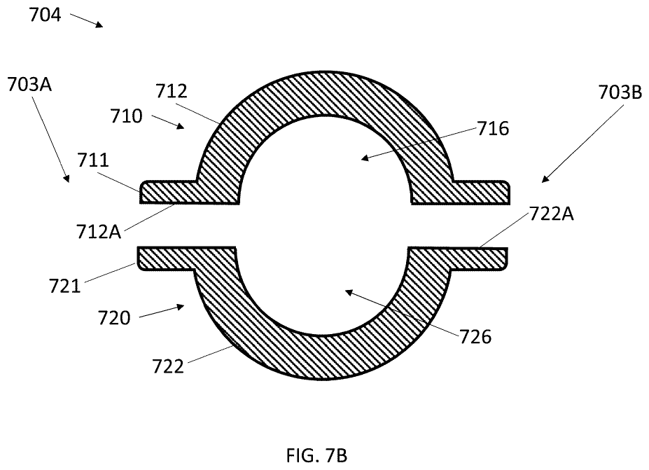

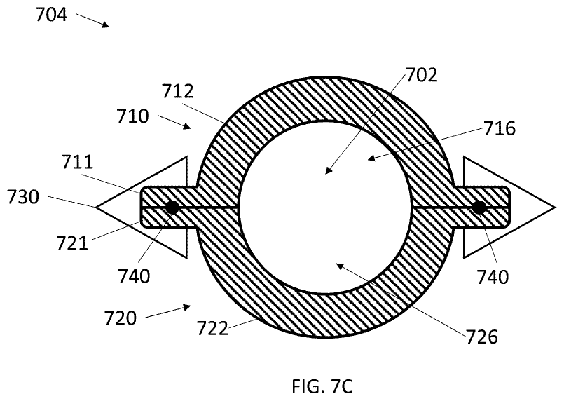

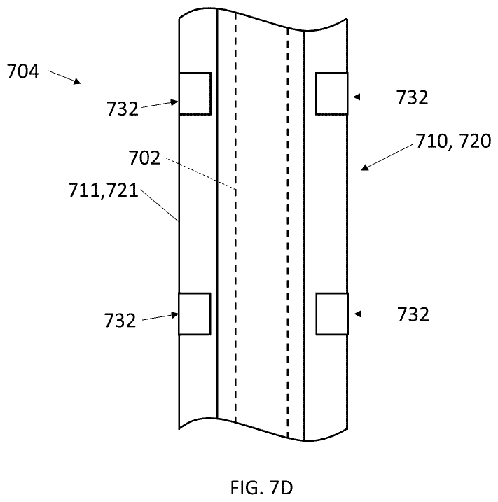

FIGS. 7A-7D illustrate a dispensing tube 704. The dispensing tube 704 may be bisected from the first end 704A of the dispensing tube 704 to the second end 704B of the dispensing tube 704 opposite the first end 704A. The dispensing tube 704 may be laterally bisected (e.g., from a first side 703A of the dispensing tube 704 to a second side 703B of the dispensing tube 704, as shown in FIGS. 7B and 7C. The dispensing tube 704 may include a first portion 710 and a second portion 720. The first portion 710 may form a top portion or top half of the dispensing tube 704 and the second portion 720 may form a bottom portion or bottom half of the dispensing tube 704. The first portion 710 and the second portion 720 may extend from the first end 704A of the dispensing tube 704 to the second end 704B of the dispensing tube. The first portion 710 and the second portion 720 may be coupled together to form the dispensing tube 704.

The first portion 710 may include a body 712, and/or a recess 716. The first portion 710 may include a first end 718 and a second end 719. The first end 718 of the first portion 710 may be the first end 704A of the dispensing tube 704, and the second end 719 of the first portion 710 may be the second end 704B of the dispensing tube 704. The body 712 may extend from the first end 718 of the first portion 710 to the second end 719 of the first portion 710. The body 712 may be shaped so the first end 718 of the first portion 710 and the second end 719 of the first portion 710 face a same direction. In some embodiments, the body 712 may be u-shaped.

The recess 716 may extend into the body 712 from a bisection surface 712A of the body 712. The recess 716 may extend from the first end 718 of the first portion 710 to the second end 719 of the first portion 710. In some embodiments, the recess 716 may be shaped so a cross-section of the recess 716 includes a same shape as a cross-section of the body 712. In some embodiments, the recess 716 may be shaped so the cross-section of the recess 716 includes a different shape as the cross-section of the body 712. In some embodiments, the cross-section of the recess 716 may be shaped as a rectangle, a semi-circle, a square, a triangle, a semi-oval, and/or any other shape.

The second portion 720 may include a body 722 and/or a recess 726. The second portion 720 may include a first end 728 and a second end 729. The first end 728 of the second portion 720 may be the first end 704A of the dispensing tube 704, and the second end 729 of the second portion 720 may be the second end 704B of the dispensing tube 704. The body 722 may extend from the first end 728 of the second portion 720 to the second end 729 of the second portion 720. The body 722 may be shaped so the first end 728 of the second portion 720 and the second end 729 of the second portion 720 face a same direction. In some embodiments, the body 722 may be u-shaped.

The recess 726 may extend into the body 722 from a bisection surface 722A of the body 722. The recess 726 may extend from the first end 728 of the second portion 720 to the second end 729 of the second portion 720. In some embodiments, the recess 726 may be shaped so a cross-section of the recess 726 includes a same shape as a cross-section of the body 722. In some embodiments, the recess 726 may be shaped so the cross-section of the recess 726 includes a different shape as the cross-section of the body 722. In some embodiments, the cross-section of the recess 726 may be shaped as a rectangle, a semi-circle, a square, a triangle, a semi-oval, and/or any other shape.

As shown in FIG. 7C, the first portion 710 of the dispensing tube 704 and the second portion 720 of the dispensing tube 704 may be coupled together to form the dispensing tube 704. The first portion 710 and the second portion 720 may be coupled together so the bisection surface 712A of the body 712 of the first portion 710 contacts the bisection surface 722A of the body 722 of the second portion 720. The first portion 710 may be placed over the second portion 720. The first portion 710 and the second portion 720 may be coupled together so the first end 718 of the first portion 710 is aligned with the second end 729 of the second portion 720 and/or the second end 719 of the first portion 710 is aligned with the first end 728 of the second portion 720.

When the first portion 710 is coupled to the second portion 720 the recess 716 of the first portion 710 and the recess 726 of the second portion 720 may form an opening 702 through the dispensing tube 704 that extends from the first end 704A of the dispensing tube 704 to the second end 704B of the dispensing tube 704.

The first portion 710 and the second portion 720 may include arms 711, 721. The arms 711 of the first portion 710 may extend laterally from the body 712 of the first portion 710. The arms 721 of the second portion 720 may extends laterally from the body 722 of the second portion 720. The arms 711, 721 may be positioned so the arms 711, 721 form at least a portion of the bisection surface 712A, 722A. When the first portion 710 and the second portion 720 are coupled together, the arms 711 of the first portion 710 may contact the arms 721 of the second portion.

The arms 711, 721 may be configured to receive clamps 730. The arms 711, 721 may include recesses 732 configured to receive the clamps 730. The clamps 730 may be coupled to the arms 711, 721 to prevent the first portion 710 and the second portion 720 from decoupling.

The arms 711 of the first portion 710 and/or the arms 721 of the second portion 720 may include seals 740. The seals 740 may be coupled to the arms 711 of the first portion 710 and the seals 740 may be inserted into seal channels in the arms 721 of the second portion 720 when the first portion 710 and the second portion 720 are coupled together. The seals 740 may be coupled to the arms 721 of the second portion 720 and the seals 740 may be inserted into seal channels in the arms 711 of the first portion 710.

The seals 740 may form a watertight seal between the first portion 710 and the second portion 720. The seals 740 may prevent or inhibit a beverage and/or beverage component in the opening 702 of the dispensing tube 704 from leaking or flowing out of the opening 702 between the arms 711, 721. Accordingly, the beverage and/or beverage component may only flow out of the opening 702 at the first end 704A and/or the second end 704B.

### Certain Terminology

As used herein, the term “beverage” has its ordinary and customary meaning, and includes, among other things, any edible liquid or substantially liquid substance or product having a flowing quality (e.g., juices, coffee beverages, teas, milk, beer, wine, cocktails, liqueurs, spirits, cider, soft drinks, flavored water, energy drinks, soups, broths, combinations of the same, or the like).

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Numbers preceded by a term such as “about” or “approximately” include the recited numbers and should be interpreted based on the circumstances (e.g., as accurate as reasonably possible under the circumstances, for example. For example, “about 1 gram” includes “1 gram.” In the embodiments described in this application, terms such as “about” or “approximately” within the specification or claims that precede values or ranges can be omitted such that this application specifically includes embodiments of the recited values or ranges with the terms “about” or “approximately” omitted from such values and ranges such that they can also be claimed without the terms “about” or “approximately” before the disclosed range. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

The following example embodiments identify some possible permutations of combinations of features disclosed herein, although other permutations of combinations of features are also possible.

### SUMMARY

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable. In addition, although this disclosure describes certain embodiments and examples of beverage systems and methods, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of pressure activated dispensing systems have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

What is claimed is:

1. A beverage dispenser comprising:
a housing;
a recess in the housing configured to hold a beverage;
an inlet; and
a dispensing tube comprising a first end and a second end,
wherein the recess is pressurized via the inlet, and wherein the second end of the dispensing tube is positioned outside of the recess, and the first end of the dispensing tube extends into the recess so the beverage in the recess is dispensed through the second end of the dispensing tube when the recess is pressurized.

2. The beverage dispenser of claim 1, further comprising a base positioned at a bottom of the recess, wherein the base is configured to draw the beverage towards a center of the base.

3. The beverage dispenser of claim 2, wherein the base is integrated into the recess.

4. The beverage dispenser of claim 2, wherein the base comprises a reservoir at the center of the base, wherein the reservoir extends into the base towards a bottom of the recess.

5. The beverage dispenser of claim 4, wherein the first end of the dispensing tube extends into the reservoir.

6. The beverage dispenser of claim 4, further comprising a plug removably inserted into the reservoir.

7. The beverage dispenser of claim 4, further comprising an agitator extending from the reservoir.

8. The beverage dispenser of claim 1, wherein the dispensing tube is longitudinally bisected.

9. The beverage dispenser of claim 1, wherein the dispensing tube is laterally bisected.

10. A beverage dispensing system comprising:
a plurality of beverage dispensers comprising:
a housing;
a recess in the housing configured to hold a beverage;
an inlet; and
a dispensing tube comprising a first end and a second end,
wherein the recess is pressurized via the inlet, and wherein the second end of the dispensing tube is positioned outside of the recess, and the first end of the dispensing tube extends into the recess so the beverage in the recess is dispensed through the second end of the dispensing tube when the recess is pressurized; and
a dispensing head comprising a plurality of openings,
wherein the second end of the dispensing tube of each of the plurality of beverage dispensers is inserted into one of the plurality of openings.

11. The beverage dispensing system of claim 10, wherein the beverage in the recess of each of the plurality of beverage dispensers is dispensed into a beverage container positioned under the dispensing head.

12. The beverage dispensing system of claim 10, further comprising a communication module configured to receive a beverage order from a point of sale system.

13. The beverage dispensing system of claim 12, wherein the beverage dispensing system is configured to dispense the beverage in the recess of at least one of the plurality of beverage dispensers based on the beverage order.

14. The beverage dispensing system of claim 10, further comprising a user interface configured to receive a user input indicative of a particular beverage to dispense, wherein the particular beverage is the beverage in the recess of at least one of the plurality of beverage dispensers and wherein the beverage dispensing system dispenses the particular beverage based on the user input.

15. The beverage dispensing system of claim 14, wherein the dispensing tube of one or more of the plurality of beverage dispensers is bisected from the first end of the dispensing tube to the second end of the dispensing tube.

16. A dispensing tube for a beverage dispenser, the dispensing tube comprising:
a first end;
a second end opposite the first end;
a first portion extending from the first end to the second end, the first portion comprising a first body and a first recess in the first body; and
a second portion extending from the first end to the second end, the second portion comprising a second body and a second recess in the second body,
wherein the first portion and the second portion are configured to removably couple together so the first recess and the second recess form an opening in the dispensing tube extending from the first end to the second end.

17. The dispensing tube of claim 16, wherein the dispensing tube is longitudinally bisected so the first portion forms a right half of the dispensing tube and the second portion forms a left half of the dispensing tube.

18. The dispensing tube of claim 16, wherein the dispensing tube is laterally bisected so the first portion forms a top half of the dispensing tube and the second portion forms a bottom half of the dispensing tube.

19. The dispensing tube of claim 16, wherein the first portion comprises seals, and the second portion comprises seal channels, and wherein the seals extend into the seal channels to form a watertight seal when the first portion and the second portion are coupled together.

20. The dispensing tube of claim 16, wherein the dispensing tube further comprises clamps configured to couple the first portion to the second portion.
